(19) United States
(12) Patent Application Publication
(10) Pub. No.: US 2007/0005405 A1
(43) Pub. Date: Jan. 4, 2007

(54) INSURANCE SYSTEM AND METHOD

(76) Inventors: Larry R. Dust, Indianapolis, IN (US); Wallace T. Gray, Carmel, IN (US)

Correspondence Address: BAKER & DANIELS LLP, 300 NORTH MERIDIAN STREET, SUITE 2700, INDIANAPOLIS, IN, 46204, US

(21) Appl. No.: 11/531,109

(22) Filed: Sep. 12, 2006

(51) Int. Cl. G06Q 40/00

(52) U.S. Cl. 705/4

(57) ABSTRACT

An insurance benefit plan is disclosed including one or more insurance modules whereby at least one of the insurance modules is a limited medical benefit program.

### FIELD OF THE INVENTION

The present invention relates to methods and systems for providing an insurance benefit plan and in particular to methods and systems for providing an insurance benefit plan including one or more insurance modules whereby at least one of the insurance modules is a limited medical benefit program.

### BACKGROUND OF THE INVENTION

One type of insurance benefit plan is a health insurance plan, such as a major medical benefit program. Many individuals cannot afford and/or are not eligible for a major medical benefit program through their place of employment. In general, a major medical benefit program may be self-funded by an employer. The employer has traditionally paid at least a portion or all of the cost associated with the major medical benefit program. Costs include administrative expenses and claims.

However, over time the costs associated with major medical benefit programs have increased dramatically. This has resulted in either (1) the employer shifting more of the cost burden to the employee (which may result in the employee dropping coverage due to increased cost); (2) the employer scaling back the coverage provided by the major medical benefit program; and/or (3) the employer discontinuing the major medical benefit program. The result being that employees are uninsured or, if the major medical benefit program is still in existence, perceive the major medical benefit program as less of a benefit of employment.

In addition to cost concerns, many employees are not eligible for coverage under an employer's major medical benefit program for a variety of reasons. For instance, the employer may not offer coverage under the major medical benefit program to an employee until the employee has been with the company for a given period of time, such as a year. In another example, the employer may not offer coverage under the major medical benefit program to part time and/or seasonal employees.

It is known that an employer sponsored medical benefit program may place different benefit modules or programs within a single benefit plan. Exemplary benefit modules may include but need not include a first major medical benefit program, a second major medical benefit program, a vision benefit program, a prescription drug benefit program, and/or a dental benefit program. A known method for combining these benefit modules into a single benefit plan is through the use of a wrap document which wraps around and encapsulates all benefit programs that the employer elects to put under the single benefit plan. At the end of the benefit plan year a single Form 5500 will be filed for the benefit plan as it relates to all programs under the wrap document.

Another type of health insurance plan is a limited medical benefit program. A limited medical benefit program is limited in the type of coverage provided. In general a limited medical benefit program does not include catastrophic coverage such as provided by major medical benefit programs. What limited medical benefit programs do cover are high frequency generally lower cost claims. For example, a limited medical benefit program may pay a given dollar amount for each day that a patient is in a hospital, a given dollar amount for a surgical procedure, a given dollar for an office visit to a physician, a given dollar amount for a visit to an emergency room, or a given dollar amount for prescription drugs. In general, a limited medical benefit program may be structured to provide coverage for a high percentage of treatments required. One estimate is that a limited medical benefit program may provide coverage for about ninety-one percent of the treatments required by an average individual.

Limited medical benefit programs are available from insurance companies. The premium set by the insurance companies are known as a fully insured premium. The fully insured premium includes built in assumptions about the amount of claims to be paid, the amount of expenses to be paid, such as administration and commissions, reserves for incurred but not reported (IBNR) claims, premium stabilization funds, as well as any other expected costs. In addition, the fully insured premium includes a profit or gain to be made by the insurance company. This profit or gain varies based on the insurance carrier and benefit design and may be as large as about 20 percent to about 30 percent.

A limited medical benefit program may be structured to include a variety of different types of coverage. Exemplary systems for structuring a limited medical benefit program are provided in the following three pending applications: U.S. patent application Ser. No. 11/479,206; filed Jun. 30, 2006, titled “METHOD FOR CUSTOMIZING INSURANCE PLANS”; U.S. patent application Ser. No. 11/478,909; filed Jun. 30, 2006, titled “SOFTWARE FOR CUSTOMIZING INSURANCE PLANS”; and U.S. patent application Ser. No. 11/480,227; filed Jun. 30, 2006, titled “SYSTEM FOR CUSTOMIZING INSURANCE PLANS”, the disclosures each of which are expressly incorporated by reference herein.

An advantage of a limited medical benefit program is that an employer may provide coverage to an employee for hopefully a large percentage of expected treatments without having to pay a large amount for the coverage. A disadvantage is that coverage for catastrophic events is not typically provided. A need exists to provide insurance coverage to as many employees as possible, including a major medical benefit program for at least a portion of the employees, while controlling the costs of providing the coverage.

### SUMMARY OF THE INVENTION

In an exemplary embodiment of the present invention, a method and system are provided for grouping a plurality of benefit modules into a single benefit entity, wherein at least one of the plurality of benefit modules is a limited medical benefit program. In one example, the employee contributions to the benefit entity for the limited medical benefit program are set generally in line with a fully insured premium for similar coverage using techniques that may be a part of the patent applications listed above. In another example, the employee contributions to the benefit entity for the limited medical benefit program are set generally in line with a fully insured premium for similar coverage using other methods of calculation.

In another exemplary embodiment of the present invention, a method of structuring a benefit plan is provided. The method including the steps of: establishing a benefit plan; and grouping a plurality of benefit modules into the benefit plan. At least one of the plurality of benefit modules is a limited medical benefit program. In one example, a funding entity is established to receive assets related to the plurality of benefit modules of the benefit plan. The received assets are treated as a single source of funding for a plurality of benefit disbursements. The plurality of benefit disbursements being related to one or more of the plurality of benefit modules. In one variation, the assets received by the funding entity include employee contributions which are made by either pre-tax contributions or after tax contributions. In a further example, the benefit plan is a self-funded benefit plan established by an employer.

In yet another exemplary embodiment of the present invention, a method of structuring an insurance plan is provided. The method including the steps of: providing a self-funded insurance plan including a major medical benefit module and a limited medical benefit module; offering the major medical benefit module to a first group of persons; and offering the limited medical benefit module to a second group of persons.

In still another exemplary embodiment of the present invention, a method of controlling employer costs associated with a benefit plan over a prior benefit plan having a prior benefit plan employer cost. The method comprising the step of: providing a combined benefit plan having at least two benefit modules. A first benefit module being a major medical benefit module and a second benefit module being a limited medical benefit module. The combined benefit plan is structured to have a lower employer cost than the prior benefit plan employer cost. In one example, the method includes the step of pricing the limited medical benefit module to generate a reserve of assets resulting in the lower employer cost.

Additional features of the present invention will become apparent to those skilled in the art upon consideration of the following detailed description, which includes the presently perceived best mode of carrying out the invention.

### BRIEF DESCRIPTION OF THE DRAWINGS

FIG. 1A is a diagrammatic representation of a first benefit plan having a benefit module A;

FIG. 1B is an illustrative example of the monies provided for the first benefit plan of FIG. 1A and the monies paid out for the first benefit plan of FIG. 1A;

FIG. 1C is a diagrammatic representation of a second benefit plan having a limited medical benefit module;

FIG. 1D is an illustrative example of the monies provided for the second benefit plan of FIG. 1C and the monies paid out for the second benefit plan of FIG. 1C;

FIG. 1E is another illustrative example of the monies provided for the second benefit plan of FIG. 1C and the monies paid out for the second benefit plan of FIG. 1C;

FIG. 1F is a diagrammatic representation of a third benefit plan having the benefit module A of FIG. 1A and the limited medical benefit module of FIG. 1C;

FIG. 1G is a first illustrative example of the monies provided for the third benefit plan of FIG. 1F and the monies paid out for the third benefit plan of FIG. 1F, the first illustrative example having a ratio of insured lives of 1:1 for the benefit module A and the limited medical benefit module;

FIG. 1H is a second illustrative example of the monies provided for the third benefit plan of FIG. 1F and the monies paid out for the third benefit plan of FIG. 1F, the second illustrative example having a ratio of insured lives of 1:4 for the benefit module A and the limited medical benefit module;

FIG. 1I is a third illustrative example of the monies provided for the third benefit plan of FIG. 1F and the monies paid out for the third benefit plan of FIG. 1F, the third illustrative example having a ratio of insured lives of 1:7 for the benefit module A and the limited medical benefit module;

FIG. 1J is a fourth illustrative example of the monies provided for the third benefit plan of FIG. 1F and the monies taken paid out for third benefit plan of FIG. 1F, the fourth illustrative example having a ratio of insured lives of 1:4 for the benefit module A and the limited medical benefit module;

FIG. 2 is a diagrammatic representation of an exemplary benefit plan including a major medical benefit program and a limited medical benefit program;

FIG. 3 illustrates an exemplary illustration of the flow of assets related to the benefit pan of FIG. 2; and

FIG. 4 illustrates another exemplary illustration of the flow of assets related to the benefit pan of FIG. 2.

### DETAILED DESCRIPTION OF THE DRAWINGS

The embodiments described herein are merely exemplary and are not intended to limit the invention to the precise forms disclosed. Instead, the embodiments were selected for description to enable one of ordinary skill in the art to practice the invention.

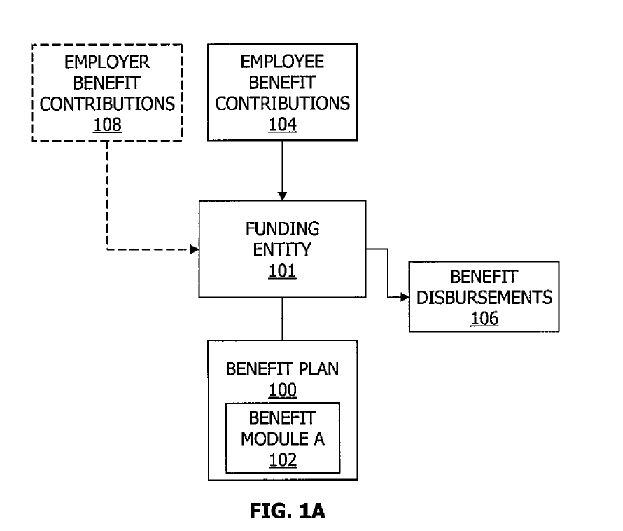

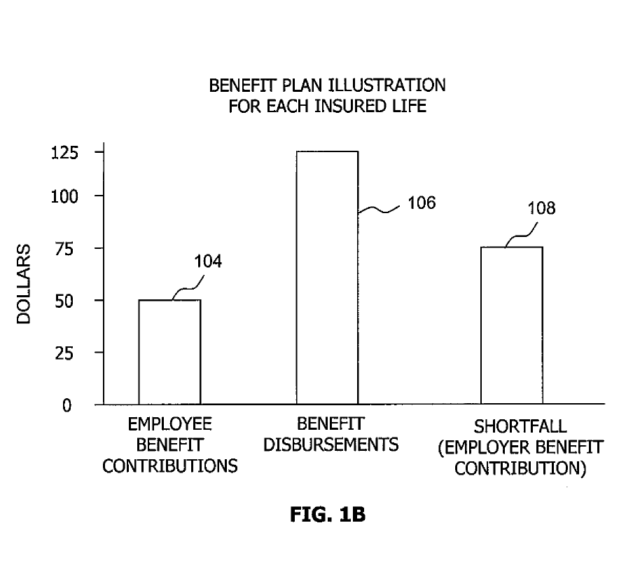

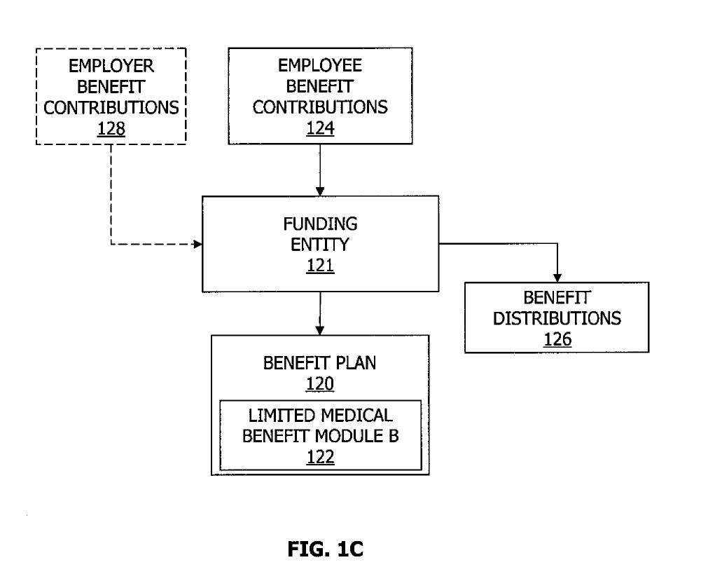

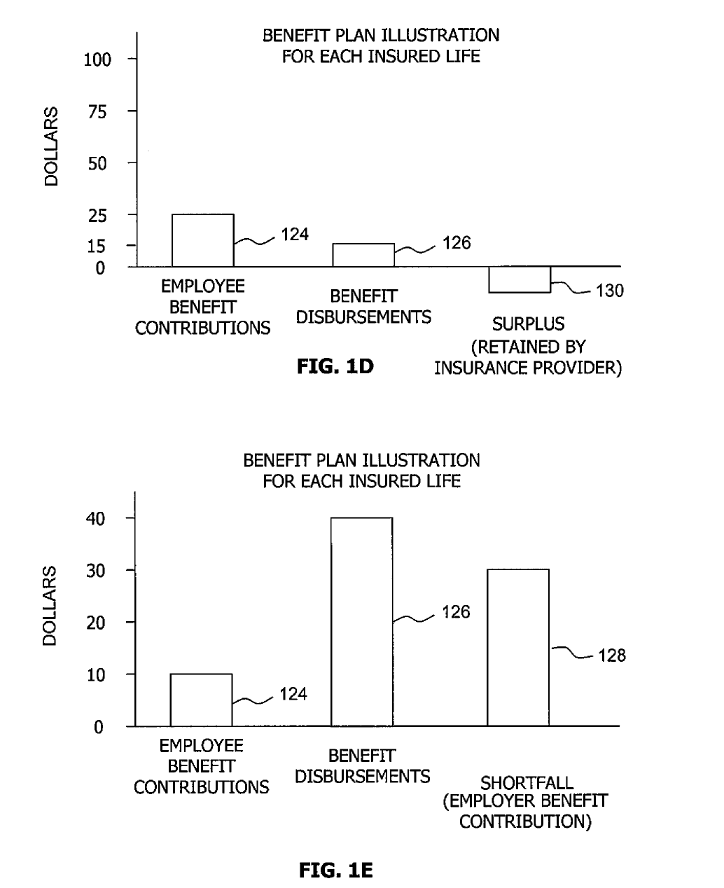

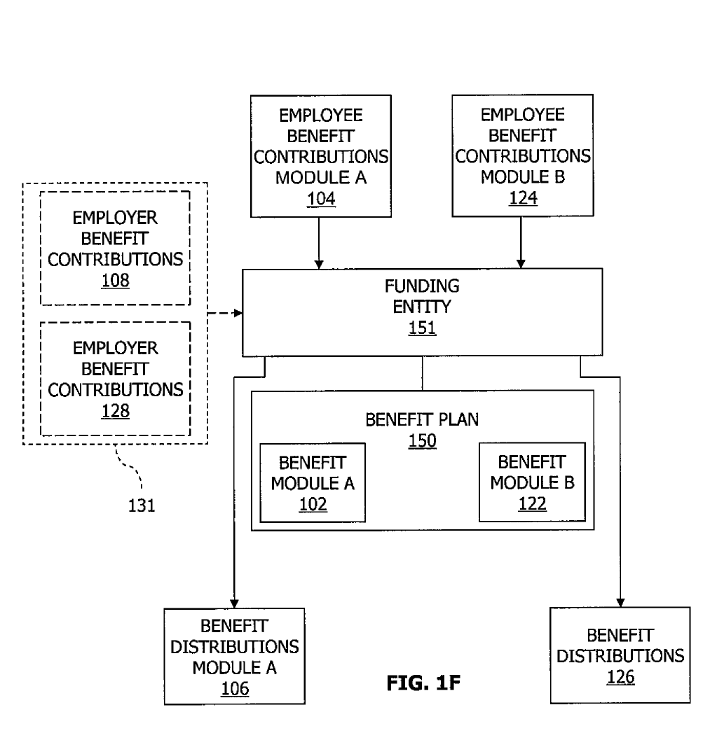

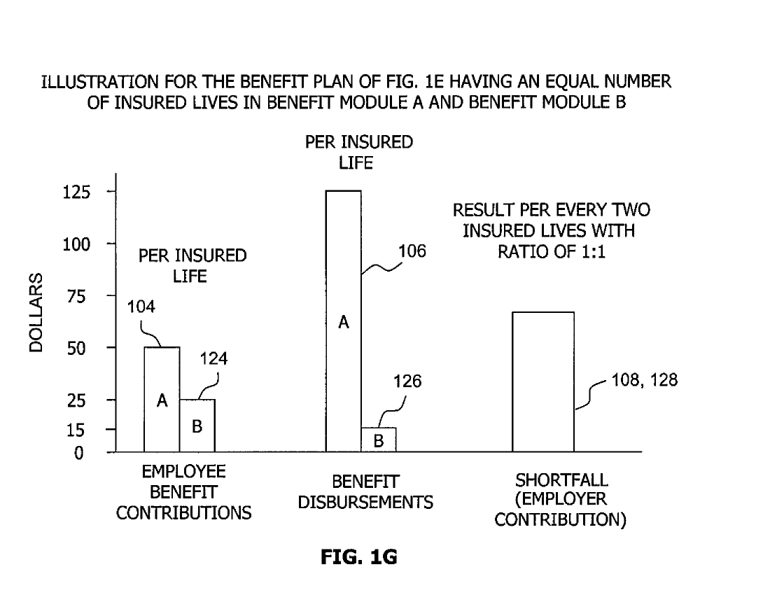

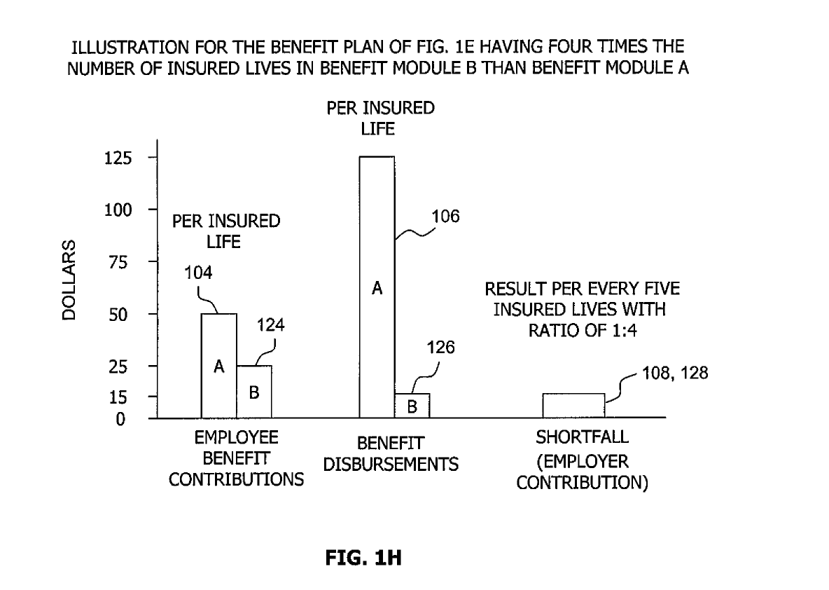

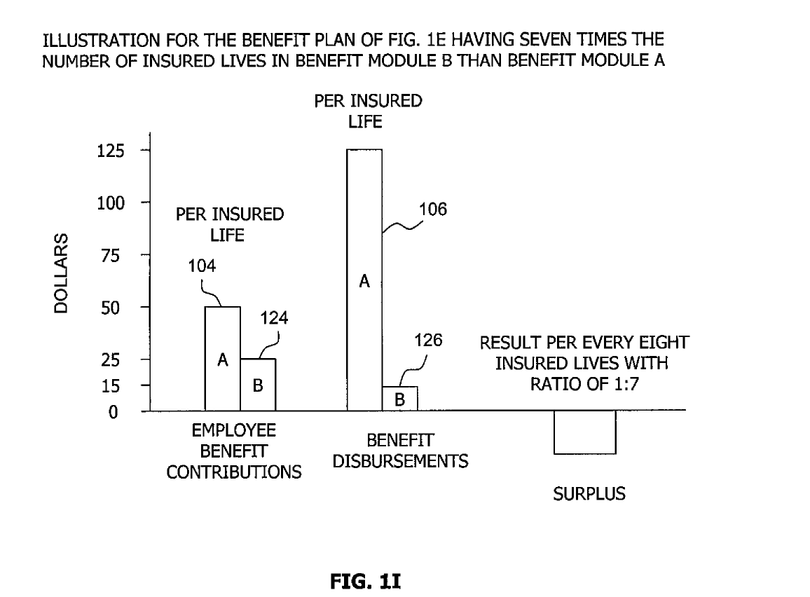

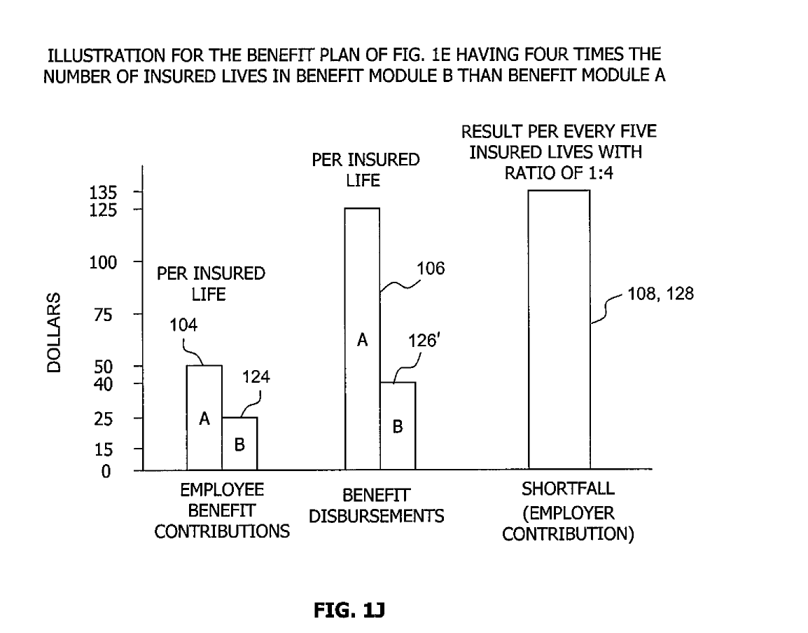

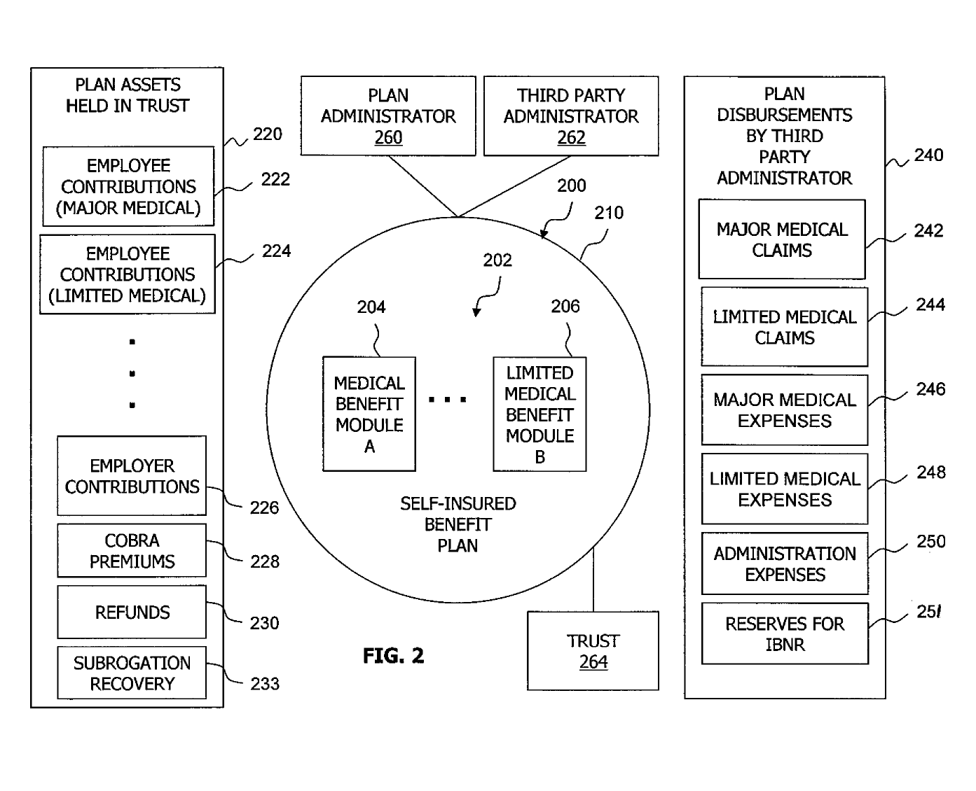

Disclosed herein are benefit plans which include multiple benefit modules each providing different types of coverage. Exemplary benefit plans include benefit plan 150 (see FIG. 1F) which includes multiple benefit modules (illustratively benefit modules 102 and 122) each providing different types of coverage and benefit plan 200 which includes multiple benefit modules 202 (illustratively benefit modules 204 and 206) each providing different types of coverage.

Benefit plan 200 as shown in FIG. 2, illustratively includes a first benefit module 204 which is a major medical benefit program and a second benefit module 206 which is a limited medical benefit program. In one embodiment, first benefit module 204 is a different type of benefit program than a major medical benefit program. In one embodiment benefit plan 200 includes at least three or more benefit modules. In the illustrated embodiment, benefit plan 200 is directed to be setup by a plan administrator 260, typically the employer, which is responsible for funding any shortfalls encountered in the administration of benefit plan 200. As such, benefit plan 200 is a self-funded benefit plan. As illustrated, benefit plan 200 is administered by a third party administrator 262 under the direction of plan administrator 260. In one embodiment, plan administrator 260 is responsible for the administration of benefit plan 200. In one example, plan administrator 260 is a representative of the employer.

As explained herein, benefit plan 200 may operate to reduce or eliminate the amount of shortfalls payable by the employer in the administration of benefit plan 200. Further, as explained herein, benefit plan 200 provides an employer the ability to provide a major medical program to a first group of employees and to provide a limited medical benefit program to a second group of employees which would otherwise have either been ineligible for the major medical benefit program or may be unable to afford to participate in the major medical benefit program.

The advantage of benefit plan 200 may be illustrated through a discussion of FIGS. 1A-1J. The numerical values presented in FIGS. 1A-1J are provided for illustration only and should not be considered to reflect actual contributions, disbursements, shortfalls, or surpluses.

Referring to FIG. 1A, a first benefit plan 100 is shown having a benefit module A 102. Benefit plan 100 is a self-funded benefit plan wherein the enrolled employees make employee benefit contributions 104 for benefit plan 100 and benefit disbursements 106 are paid out based on the presentment of claims by either the employee or a healthcare provider of the employee. Exemplary employee benefit contributions 104 include premium contributions. In the case wherein an amount of benefit disbursements 106 to be made exceeds an amount of benefit contributions 104 provided for benefit plan 100, a shortfall is created. The employer is responsible to make employer benefit contributions 108 to make up such a shortfall. Exemplary benefit disbursements include insurance claims, reserves for payment of IBNR claims, premium stabilization funds, administrative expenses, and other suitable benefit expenses.

As shown in FIG. 1A, employee contributions 104 and employer contributions 108 are paid into a funding entity 101 which handles the assets for benefit plan 100. An exemplary funding entity is a trust which is setup through a trust instrument. In one embodiment, employee contributions 104 are made on a pre-tax basis. In one embodiment, employee contributions 104 are made on an after-tax basis. In either case, the employer may deduct the employee contribution 104 from the respective employees paycheck and provide the employee contribution 104 to funding entity 101. Funding entity 101 also pays out of the assets for benefit plan 100 the benefit disbursements 106 to be paid.

Referring to FIG. 1B, an illustrative example for each insured life of benefit module 102 is shown. Each insured life of benefit module 102 provides employee benefit contributions 104 of 50 dollars for benefit plan 100. However, benefit disbursements 106 of 125 dollars are required to be paid out for benefit plan 100 for each insured life. This leaves a shortfall of 75 dollars for each insured life requiring employer benefit contributions 108 of 75 dollars to be provided for benefit plan 100 for each insured life.

Referring to FIG. 1C, a second benefit plan 120 is shown having a limited medical benefit module 122. Benefit plan 120 is a self-funded benefit plan wherein the enrolled employees make employee benefit contributions 124 which are paid into a funding entity 121 which handles the assets for benefit plan 120. An exemplary funding entity is a trust which is setup through a trust instrument. In one embodiment, employee contributions 124 are made on a pre-tax basis. In one embodiment, employee contributions 124 are made on an after-tax basis. In either case, the employer may deduct the employee contribution 124 from the respective employee's paycheck and provide the employee contribution 124 to funding entity 121. Funding entity 121 also pays out of the assets for benefit plan 120 the benefit disbursements 126 to be paid.

Exemplary employee benefit contributions 124 include premium contributions. In the case wherein an amount of benefit disbursements 126 to be made exceeds an amount of employee benefit contributions 124 provided for benefit plan 120 the employer is responsible to make employer benefit contributions 128 to make up such a shortfall. Exemplary benefit disbursements include insurance claims, reserves for payment of IBNR claims, premium stabilization funds, administrative expenses, and other suitable benefit expenses. However, since the benefits provided under limited medical benefit module 122 are limited the employee benefit contributions 124 may be set at a value such that employer benefit contributions 128 may or may not be required.

Referring to FIG. 1D, an illustrative example for each insured life of benefit module 122 is shown. Each insured life of benefit module 122 provides employee benefit contributions 124 of 25 dollars for benefit plan 120. However, benefit disbursements 126 of only 15 dollars are required to be paid out for benefit plan 120 for each insured life due to the limited benefits provided under benefit module 122.

This leaves a surplus 130 of 10 dollars. Since benefit plan 120 results in a surplus of 10 dollars, the employer is not required to make a contribution to make up a shortfall. Further, if plan 120 is a fully insured benefit plan provided by a third party insurance provider, not an employer self-funded plan, then surplus 130 is retained by the insurance provider.

It should be understood that in a fully insured limited medical benefit program, as well as an employer self-funded limited medical benefit program, a given insured life may have benefit disbursements that exceed the amount of employee benefit contributions made by that insured life for the fully insured limited medical benefit program. Otherwise the insured individual would not purchase the fully insured limited medical benefit from the insurance company or enroll in the employer's self-funded program. However, in the fully insured example, the insurance company sets the fully insured premium for the limited medical benefit high enough to make sure that the fully insured premiums collected over a population of insured lives generally exceed the disbursements required to be paid for that same population of insured lives. Otherwise the insurance company would not offer to sell fully insured limited medical benefit programs because there would not be any profit for the insurance company.

As explained herein, each of benefit plans 150 and 200 includes a respective self-funded limited medical benefit module 122 and 206. The following discussion is illustrated for benefit plan 200, but is applicable to benefit plan 150 as well. By including limited medical benefit module 206 with other benefit modules 202, a surplus related to limited medical benefit module 206, such as surplus 130, may be retained and used to cover benefit disbursements 240 which originate in connection with any of benefit modules 202.

In one embodiment, the premiums for the self-funded limited medical benefit program 206 are set generally at an equivalent to a corresponding fully insured premium offered by the insurance industry. As such, the employer may realize a surplus on limited medical benefit program 206 which may be used to support the remaining benefit modules 202. In addition, the insured lives in the limited medical benefit program 206 receive insurance coverage at a competitively priced premium, an equivalent to the fully insured premium. The fully insured premiums for the self-funded limited medical benefit program may be obtained from market information. Alternatively, equivalent fully insured premiums may be provided by third parties, such as Key Benefit Administrators located at 8330 Allison Pointe Trail, Indianapolis, Ind. 46250.

It should be understood that the employer may set the premium of the self-funded limited medical benefit program 206 of benefit plan 200 lower than the fully insured premium to provide a better priced insurance product to the eligible employees but still high enough to cover the cost of benefit disbursements associated with the limited medical benefit program 206 and perhaps generate a surplus from the limited medical benefit program 206. Further, the employer may set the premium of the self-funded limited medical benefit program 206 lower than the fully insured premium to provide a better priced insurance product to the eligible employees and lower than the amount of benefit disbursements associated with the limited medical benefit program 206 to be paid. As such, the employer is paying a portion of the cost of the limited medical benefit program 206. An example of such a situation is shown in FIG. 1E which relates to benefit plan 120.

Referring to FIG. 1E, another illustrative example for each insured life of benefit module 122 is shown. Each insured life of benefit module 122 provides employee benefit contributions 124 of 10 dollars for benefit plan 120. Benefit disbursements 126 of 40 dollars are required to be paid out for benefit plan 120 for each insured life. This leaves a shortfall of 30 dollars per insured life. Employer 114 is required to make an employer contribution 128 of 30 for each insured life.

Further, the employer may set the premium of the limited medical benefit program in the first year with the estimate of receiving a first surplus amount from the limited medical benefit program and then adjust the premium in future years if the actual surplus is too low or too high. The actual surplus amount may vary based on a difference between the actual number of lives insured and the estimated number of lives insured and a difference between actual benefit disbursements and estimated future benefit disbursements.

Referring to FIG. 1F, a benefit plan 150 includes both benefit module A 102 of FIG. 1A and limited medical benefit module B 122 of FIG. 1C. In one embodiment, benefit plan 150 is a self-funded employer benefit plan. Employee benefit contributions 104, 124 are provided to a funding entity 151, that is used to hold the benefit contributions 104, 124 as required by employee benefit laws, rules and regulations. Funding entity 151 then uses benefit contributions 104, 124 to pay benefit disbursements 106, 126 related to benefit plan 150. An exemplary funding entity is a trust which is setup through a trust instrument.

If benefit disbursements 106, 126 exceed benefit contributions 104, 124 then employer contributions 108, 128 (shown as employer contribution 131) are required to be made to funding entity 151 which uses benefit contributions 131 to pay benefit disbursements 106, 126. It should be noted that benefit contributions 104, 108, 124, and 128 are considered to form a single funding source for the payment of benefit disbursements 106, 126 irrespective of whether the contributions were intended to go towards benefit module 102 or benefit module 122. As such, a surplus generated by either of benefit modules 102 and 122 may be used to pay benefit disbursements of the other of benefit modules 102 and 122. Although benefit plan 150 is shown having only two benefit modules, 102 and 122, in other embodiments, benefit plan 150 may have at least three benefit modules, at least four benefit modules, and any other number of benefit modules.

Referring to FIG. 1G, in an illustrative example using the same numbers from the examples of FIGS. 1B and 1D, for each insured life it can be seen that by pooling employee benefit contributions 104, 124 into a single source of funding that the overall employer contribution 131 required to be paid by an employer is lowered. FIG. 1G assumes that there are an equal number of employees in benefit module A 102 and limited benefit module 122.

As shown in FIG. 1G, for each pair of employees (one insured in benefit module A 102 and one insured in limited medical benefit module 122) the total amount of employee contributions 104, 124 is 75 dollars and the total amount of benefit disbursements is 135 dollars. This results in a shortfall of 60 dollars that must be paid by the employer in the form of an employer contribution 131. The 60 dollar shortfall is less than the 75 shortfall incurred when benefit module 102 and limited benefit module 122 are provided as separate benefit plans 100, 120.

Referring to FIG. 1H, another illustrative example is shown using the same numbers from the examples of FIGS. 1B and 1D for each insured life. The illustration in FIG. 1H assumes that there are four employees in limited medical benefit module B 122 for every employee in benefit module A 102. As shown in FIG. 1G, for each grouping of five employees (one insured in benefit module A 102 and four insured in limited medical benefit module B 122) the total amount of employee contributions 104, 124 is 150 dollars and the total amount of benefit disbursements is 165 dollars. This results in a shortfall of 15 dollars that must be paid by the employer in the form of employer contribution 130.

Referring to FIG. 1I, another illustrative example is shown using the same numbers from the examples of FIGS. 1B and 1D for each insured life. The illustration in FIG. 1I assumes that there are seven employees in limited medical benefit module B 122 for every employee in benefit module A 102. As shown in FIG. 1I, for each grouping of eight employees (one insured in benefit module A 102 and seven insured in limited medical benefit module B 122) the total amount of employee contributions 104, 124 is 225 dollars and the total amount of benefit disbursements is 195 dollars. This results in a surplus of 30 dollars.

Referring to FIG. 1J, another illustrative example is shown using the same numbers from the example of FIG. 1B for each insured life. The benefit expenses 126′ shown in FIG. 1J for the limited medical benefit program 120 differ from the benefit expenses 126 shown in FIG. 1D. As shown in FIG. 1J, the benefit expenses for each insured life is $40 while the employee contributions 124 remain $25. As such, for each life insured in the limited medical benefit program 122 a shortfall of $15 must be paid by the employer.

The illustration in FIG. 1J assumes that there are four employees in limited medical benefit module B 122 for every employee in benefit module A 102. As shown in FIG. 1J, for each grouping of five employees (one insured in benefit module A 102 and four insured in limited medical benefit module B 122) the total amount of employee contributions 104, 124 is 150 dollars and the total amount of benefit disbursements is 285 dollars. This results in a shortfall of 135 dollars that must be paid by the employer in the form of employer contribution 130.

As such, for certain ratios of employees in benefit module A 102 and limited benefit module B 122 and the relative amount of employee contributions and benefit disbursements for each module, the amount of the shortfall required to be made up by the employer as employer contribution 130 may be increased, reduced, eliminated, or turned into a surplus. As discussed herein, one method of reducing or eliminating a shortfall is to set the employee contributions 124 for limited medical benefit module B 122 to provide a surplus on average for each insured life. As discussed herein, in one embodiment the employee contributions 123 are set to an amount equal to the premiums for a fully insured limited medical benefit program.

The employer may utilize the reduction in shortfall or creation of a surplus in many different ways. In one embodiment, the employer may have budgeted to make contributions in the amount of 75 dollars to funding entity 151 for the benefit plan chosen by the employer, such as benefit plan 150. In this instance the employer may use the reduction in shortfall to lower one or both of employee contributions 104 and employee contributions 124. In one embodiment, the employer may increase the benefits provided under one or both of benefit module A 102 and benefit module B 122 without passing the increased cost on to the employees as increased employee contributions 104 and 124. In one embodiment, the employer by not having to make as large an employer contribution 130 as anticipated may have additional funds for use in other areas of the business instead of being used as an employer contribution 130.

In one embodiment, the employer may have been unable to provide benefit module A 102 to its employees if the employer contribution component was to be 75 dollars per insured life. As such, without combining benefit module A 102 and limited medical benefit module B 122 into a single benefit plan 150, the employer would have to discontinue benefit module A 102 resulting in a loss of coverage for various employees of the employer. By combining benefit module A 102 and limited medical benefit module B 122 in benefit plan 150 the employer may not only preserve its ability to insure employees under benefit module A 102 and insure additional otherwise uninsured lives under limited medical benefit module B 122, but also may be able increase the amount of coverage offered under one or both of benefit module A 102 and limited medical benefit module B 122.

Referring to FIG. 2, an exemplary benefit plan 200 is shown. Benefit plan 200 includes the plurality of benefit modules 202. Benefit plan 200 is generally similar to benefit plan 150. As illustrated, benefit plan 200 includes at least a major medical benefit module 204 and a limited medical benefit module 206. In one embodiment, at least three or more benefit modules 202 are provided in benefit plan 200.

In one embodiment, major medical benefit module 204 is offered to full-time employees of the employer and limited medical benefit module 206 is offered to employees who either cannot afford major medical benefit module 204 or who are not eligible for the employer's major medical benefit module 204 because they are part time or seasonal employees or because of other reasons unique to the employer. In general, as explained herein the cost for limited medical benefit module 206 is less than the cost for major medical benefit module 204 because the benefits offered under the limited medical benefit module 206 are limited.

The contributions for both major medical benefit module 204 and limited medical benefit module 206 may be made by the employee with shortfalls made up by the employer, may be made by both the employee and the employer with shortfalls made up by the employer, or may be totally made by the employer including shortfalls.

In one embodiment, the employer may purchase reinsurance, such as stop loss insurance, to limit the amount of shortfall payable by the employer. The stop loss coverage may be purchased for each benefit module 204 and 206 separately, in the aggregate, or for less than all of benefit modules 204 and 206. For example, stop loss insurance for limited medical benefit module 206 may be structured as follows. Using a fully insured premium equivalent, the benefit plan would be collecting for instance 5 million dollars in employee contributions. A margin would be established, such as 10 percent. Therefore, the employer has agreed to pay any excess disbursements up to 10 percent of the 5 million dollars from the employee contributions. The aggregate loss company would only begin paying if disbursements exceeded 5.5 million dollars.

In one embodiment, benefit plan 200 is created as a single ERISA and HIPM compliant benefit plan and which includes both major medical benefit module 204 and limited medical benefit module 206. In one embodiment, benefit plan 200 is funded by a funding entity, illustratively a trust 264, which is established pursuant to a formal trust document. In one embodiment, trust 264 is an IRS Code 501(c)(9) voluntary employee's beneficiary association (“VEBA”) qualified trust because there may be accumulated assets. In one embodiment, trust 264 is not an IRS Code 501(c)(9) voluntary employee's beneficiary association (“VEBA”) qualified trust because there should be few accumulated assets.

Benefit modules 204 and 206 are combined together in single benefit plan 200 through a wrap document 210. Wrap document 210 wraps around and encapsulates all benefit modules that the employer elects to put under single benefit plan 200. Employee contributions 222, 224 are made to trust 264 and used exclusively for the operation of benefit plan 200 and for the payment of valid claims. When the assets of trust 264 are inadequate to cover these costs, the employer contributes additional funds to cover those costs as employer contributions 226.

In one embodiment, benefit plan 200 includes for each benefit module 202 differing eligibilities or benefit structures based on the classification of the employee. Exemplary parameters used in determining eligibilities include employment type (full time or part time/seasonal, shift), longevity of employment, location of employment facility, and other suitable parameters.

As is known in the art, the eligibility of employees for a particular benefit plan module are governed by United States federal and/or state regulations for various reasons, including the prevention of discrimination. For instance, IRS Regulation 1.105-11(c)(2)(iii)(C) would exclude part time and/or seasonal employees who do not work more than 35 hours per week nor work more than 9 months a year from the calculation of whether a self-insured benefit plan must include them for discrimination testing in a major medical benefit module under IRS Code Section 105(h).

The employer may decide some of the eligibility requirements for benefit module A and benefit module B. In one embodiment, the employer establishes a first set of criteria by which a first set of employees are eligible for major medical benefit module 204 and a second set of employees are not eligible for major medical benefit module 204, but rather are eligible for limited medical benefit module 206. In one embodiment, the employer establishes that only seasonal and part time employees are eligible for the limited medical benefit module 206 and that an employee must be full time to be eligible for major medical benefit module 204. In one embodiment, the employer establishes that only full time employees are eligible for the limited medical benefit module 206. In one embodiment, the employer establishes that both full time employees and seasonal and part time employees are eligible for the limited medical benefit module 206.

Trust 264 receives assets 220 for use in the administration of benefit plan 200. Exemplary assets 220 include major medical benefit module employee contributions 222 which are paid by employees enrolled in major medical benefit module 204, limited medical benefit module employee contributions 224 which are paid by employees enrolled in limited medical benefit module 206, employer contributions 226, COBRA premiums 228, refunds 230, and subrogation recoveries 232. Since benefit plan 200 is created as a single entity all of assets 220 are pooled or otherwise treated as a single source of funding for the payment of benefit disbursements 240.

Assets 240 are used to pay all benefit disbursements 240 irrespective of the source of each asset 220. Exemplary benefit disbursements 240 include major medical benefit claims 242, limited medical benefit claims 244, major medical program expenses 246, limited medical benefit program expenses 248, administrative expenses 250, and reserves for IBNR 251. Exemplary major medical benefit claims 242 and limited medical benefit claims 244 include claims by healthcare providers and insured individuals. Exemplary major medical program expenses 246 and limited medical benefit program expenses 248 include administrative expenses associated with the respective program 204, 206. Exemplary other benefit plan expenses 250 includes expenses not directly tied to one of the benefit modules 204, 206.

In one embodiment, employee contributions 222 and/or 224 are deducted from the employee's pay check prior to the payment of any taxes. In one example, employee contributions 222 and/or 224 are deducted pre-tax through a cafeteria plan premium only program. In one embodiment, employee contributions 222 and/or 224 are deducted from the employee's pay check after taxes. Employer contributions 226 made to benefit plan 200 come from the general assets of the employer. A Summary Plan Description is provided which sets out the terms of the benefit module A. A separate Summary Plan Description is provided which sets out the terms of the benefit module B.

In one embodiment, the administration of benefit plan 200 is done by a third party administrator 262. In one embodiment, the following items are tracked by the third party administrator 262: employee contributions made for each of modules 204 and 206, eligibility of employees for each of modules 204 and 206, and benefit disbursements 240 including claims 242, 244. In one embodiment, the third party administrator 262 processes claims on a periodic basis. In one example, the periodic basis is weekly. In another example, the periodic basis is more frequent than weekly, such as daily. In a further example, the periodic basis is less frequent than weekly, such as every two weeks.

The third party administrator 262 determines based on the assets 220 present in trust 264, such as employee contributions 222, 224, if additional funds are required to pay the current set of disbursements 240, such as claims and administrative fees. If additional funds are not required, the third party administrator 262 processes the disbursements 240 for payment out of existing assets of the funding entity for the benefit plan.

If additional funds are required, the third party administrator 262 provides an indication to the plan administrator 260 that additional funding is required to cover claims that are to be paid. Third party administrator 262 notifies plan administrator 2601 typically the employer in a self-funded situation, that additional funding is required.

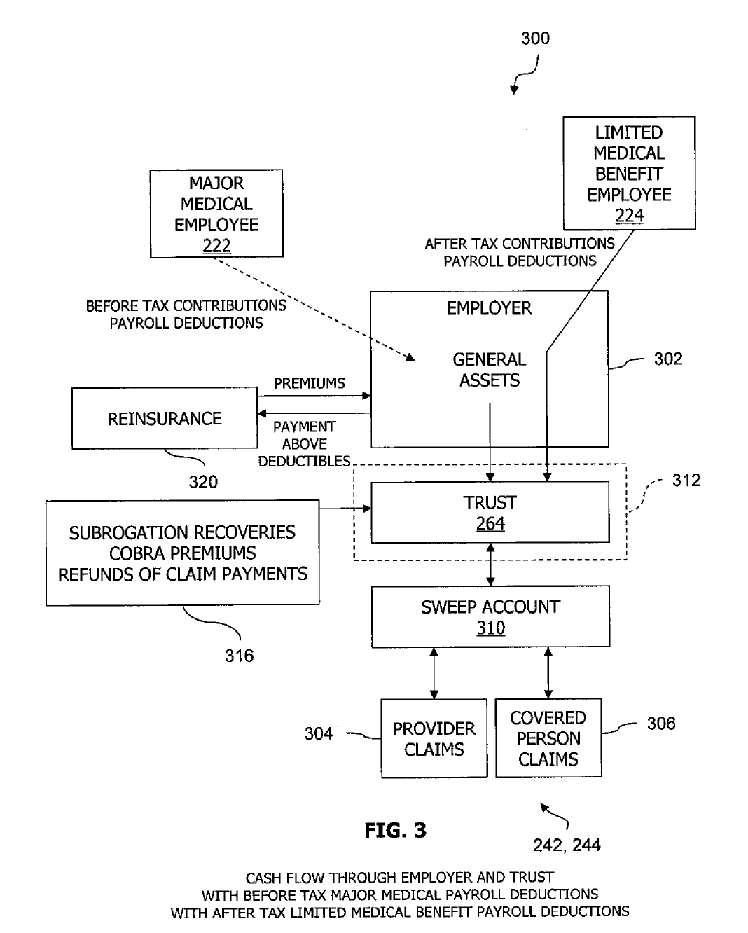

Referring to FIG. 3, a first exemplary illustration 300 of the flow of assets is shown. Trust 264 is established utilizing a formal trust document that complies with federal benefit laws to receive assets from employer 302. In general, employee benefit contributions 222, 224 are deposited to trust 264 when the employee contribution is taken as a payroll deduction and employer contributions 226 are deposited to trust 264 as needed.

As shown in FIG. 3, employee contributions 224 to trust 264 for employee's covered by benefit module B 206 as direct, post tax contributions. Employee contributions 222 for benefit module A 204 are retained by the employer as employee pre-tax salary reduction contributions. In one example, employee contributions 222 are retained through an IRS Code 125 cafeteria plan premium only program. Employee contributions 222, 224 are both deposited in trust 264.

Once in trust 264 employee contributions 222, 224 are used first to fund benefit distributions 240 from benefit plan 200. To the extent that employee contributions 222, 224 do not fully fund benefit distributions 240 from benefit plan 200, employer contributions 226 are deposited in trust 264 from the general assets of the employer and then paid out as benefit distributions 240.

Two types of benefit distributions are illustrated, provider claims 304 and covered persons claims 306. Provider claims 304 are submitted by providers of services to covered individuals. Covered individual claims 306 are submitted by individuals covered under benefit plan 200 for expenses paid by the covered individual.

As illustrated in FIG. 3, provider claims 304 and covered individual claims 306 are not paid directly out of trust 264, but rather a sweep account 310. Sweep account 310 is an “on demand” bank account. An interest bearing account 312 wherein the assets of the trust 264 are held is established by the employer. A second account, the sweep account 310 is set up to accept and pay claim payment checks. The sweep account 310 does not include sufficient assets to pay the presented claims. Rather, when a claim payment check written on the sweep account 310 is presented for payment, assets are swept from the interest bearing account 312 holding the trust assets 264 into the sweep account 310 to fund the payment.

In one embodiment, sweep account 310 is a positive pay account. In this manner, sweep account 310 functions as a fraud prevention tool. The third party administrator 262 prepares one or more checks for payment based upon the claims presented, provider claims 304 and covered persons claims 306. The third party administrator 262 then provides a listing of the check number and the amounts of each check to the bank where sweep account 310 is located. In one embodiment, this is provided electronically over a network. The check numbers and amounts are loaded into the bank's clearance system. When a check is presented for payment, the bank compares the check number and the amount of the check against the information stored in the clearance system. If the numbers match, funds are swept into sweep account 310 from interest bearing account 312 and the check is paid. If both the check number and the amount do not match, the check is not honored and it is sent to third party administrator 262.

Referring to FIG. 3, additional assets may be provided to trust 264. Exemplary additional assets 316 include subrogation recoveries, cobra premiums, and refunds of claim payments.

In the illustrated embodiment shown in FIG. 3, the employer has purchased insurance coverage 320 to limit the amount of exposure to the general assets of the employer to cover unexpected benefit claims. Exemplary types of reinsurance 320 include excess loss coverage and stop loss coverage. In one embodiment, aggregate reinsurance is purchased to cover unexpected benefit claims from any of the benefit modules. In one embodiment, reinsurance coverage is purchased for each benefit module individually. In one embodiment, the employer pays premiums for the reinsurance and the reinsurance provides payments above a preset deductible amount.

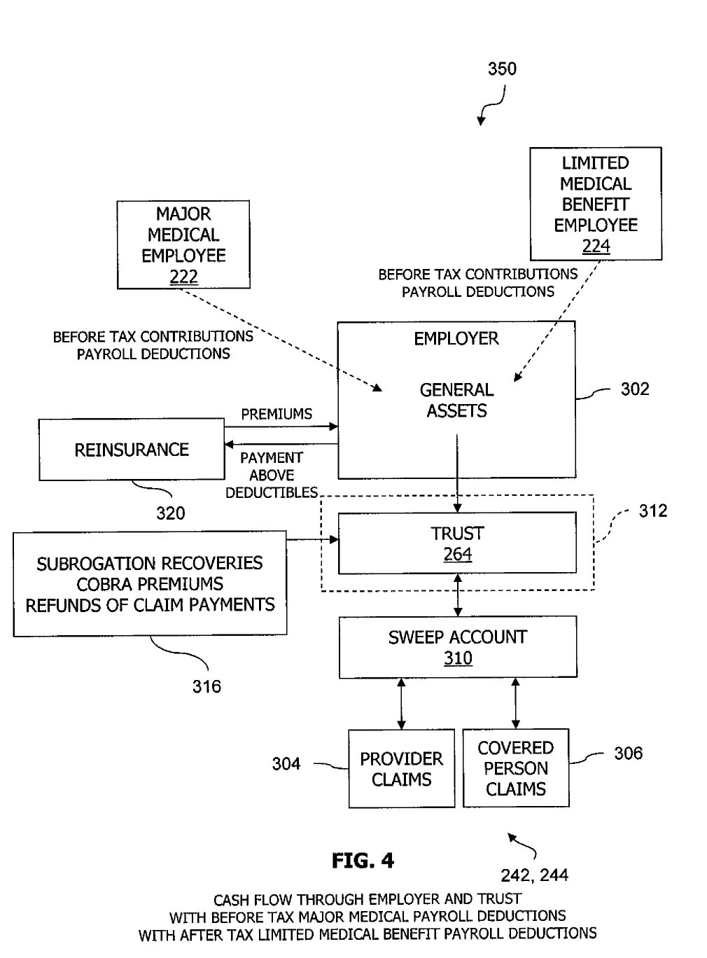

Referring to FIG. 4, a second exemplary illustration 350 of the flow of assets is shown. Illustration 350 is the same as illustration 300 except that the major medical employee contributions 222 and the limited medical benefit employee contributions 224 are withheld from the employee's pay as pre-tax employee salary reduction contributions. In one example, the major medical employee contributions 222 and the limited medical benefit employee contributions 224 are withheld from the employee's pay as apart of an IRS Code 125 cafeteria plan premium only program.

Although the present invention has been described in detail with reference to preferred embodiments, variations and modifications exist within the scope and spirit of the present invention.

1. A method of structuring a benefit plan, the method including the steps of:
establishing a benefit plan; and
grouping a plurality of benefit modules into the benefit plan, wherein at least one of the plurality of benefit modules is a limited medical benefit program.

2. The method of claim 1, further comprising the steps of:
establishing a funding entity to receive assets related to the plurality of benefit modules of the benefit plan; and
treating the received assets as a single source of funding for a plurality of benefit disbursements, the plurality of benefit disbursements being related to one or more of the plurality of benefit modules.

3. The method of claim 2, wherein the plurality of benefit modules includes a major medical benefit module.

4. The method of claim 3, wherein the assets received by the funding entity include employee contributions for the major medical benefit module and employee contributions for the limited medical benefit module.

5. The method of claim 4, wherein at least one of the employee contributions for the major medical benefit module and the employee contributions for the limited medical benefit module are pre-tax contributions.

6. The method of claim 4, wherein both of the employee contributions for the major medical benefit module and the employee contributions for the limited medical benefit module are pre-tax contributions.

7. The method of claim 1, wherein the benefit plan is a self-funded benefit plan established by an employer.

8. The method of claim 7, wherein the benefit plan is administered by a third party administrator.

9. The method of claim 7, further comprising the step of obtaining reinsurance to limit exposure of the benefit plan.

10. The method of claim 2, wherein a first portion of the received assets are associated with the limited medical benefit program and a first portion of the plurality of benefit disbursements are associated with the limited medical benefit program, an amount corresponding to the first portion of the received assets being generally greater than an amount corresponding to the first portion of the plurality of benefit disbursements.

11. A method of structuring an insurance plan, the method including the steps of:
providing a self-funded insurance plan including a major medical benefit module and a limited medical benefit module;
offering the major medical benefit module to a first group of persons; and
offering the limited medical benefit module to a second group of persons.

12. The method of claim 11, further including the steps of:
enrolling a first person from the first group in the major medical benefit module;
enrolling a second person from the second group in the limited medical benefit module;
receiving a first group of contributions from the first person;
receiving a second group of contributions from the second person; and
treating the first group of contributions and the second group of contributions as a single source of funding for all benefit disbursements.

13. The method of claim 12, further comprising the step of disbursing at least a portion of the single source of funding to pay for an expense associated with one of the major medical benefit module and the limited medical benefit module.

14. The method of claim 13, further comprising the step of disbursing another portion of the single source of funding to pay for an expense associated with the other of the major medical benefit module and the limited medical benefit module.

15. The method of claim 11, wherein an entity provides a contribution if a sum of the first group of contributions and the second group of contributions is less than an amount to be disbursed.

16. The method of claim 15, wherein the entity is the employer.

17. The method of claim 11, wherein the limited medical benefit module provides a group of benefits and the second group of contributions are based on a plurality of rates, the plurality of rates being generally equivalent to a fully insured premium for an equivalent group of benefits to the group of benefits.

18. A method of controlling employer costs associated with a benefit plan over a prior benefit plan having a prior benefit plan employer cost, the method comprising the step of:
providing a combined benefit plan having at least two benefit modules, a first benefit module being a major medical benefit module and a second benefit module being a limited medical benefit module, the combined benefit plan is structured to have a lower employer cost than the prior benefit plan employer cost.

19. The method of claim 18, further comprising the step of pricing the limited medical benefit module to generate a reserve of assets resulting in the lower employer cost.

20. The method of claim 18, wherein a difference between the prior employer cost and the lower employer cost is used to increase a group of benefits provided by at least one of the benefit modules of the benefit plan without increasing the cost to an insured employee.

21. The method of claim 18, wherein a difference between the prior employer cost and the lower employer cost is used to decrease an employee contribution to at least one of the at least two benefit modules.

22. The method of claim 18, wherein the benefit plan is a self-funded benefit plan.

23. The method of claim 18, wherein the lower employer cost is generally equal to zero.

24. The method of claim 18, wherein a second benefit module of the benefit plan is a major medical benefit module.

25. The method of claim 24, further comprising the steps of:
receiving a first group of employee contributions related to the first benefit module from a first group of employees enrolled in the first benefit module; and
receiving a second group of employee contributions related to the second benefit module from a second group of employees enrolled in the second benefit module; wherein the lower employer cost is the result of the first group of employee contributions being set to exceed a first group of benefit distributions related to the first group of employees.

26. The method of claim 25, wherein at least one of the first group of employee contributions and the second group of employee contributions are made as pre-tax contributions.

27. The method of claim 25, wherein both of the first group of employee contributions and the second group of employee contributions are made as pre-tax contributions.
